(19) United States
(12) Patent Application Publication
(10) Pub. No.: US 2025/0328343 A1
(43) Pub. Date: Oct. 23, 2025

(54) SYSTEMS AND METHODS FOR AUTOMATICALLY OPTIMIZING COMPUTER INFRASTRUCTURE BY IMPLEMENTING MULTIPLE LINES OF DEFENSE IN SOFTWARE DEVELOPMENT LIFECYCLES

(71) Applicant: JPMORGAN CHASE BANK, N.A., New York, NY (US)

(72) Inventors: James MASSA, New York, NY (US); Sangeeta SAHA, Bangaluru (IN); Chetan VERNEKAR, Edison, NJ (US)

(21) Appl. No.: 18/733,293

(22) Filed: Jun. 4, 2024

(30) Foreign Application Priority Data
Apr. 18, 2024 (IN) 202411031028

(51) Int. Cl. G06F 8/77

(52) U.S. Cl. CPC G06F 8/77

(57) ABSTRACT

Systems and methods for automatically optimizing computer infrastructure by implementing multiple lines of defense in software development lifecycles. A method may include: (1) receiving information for on-premises infrastructure and costs associated with the on-premises infrastructure; (2) mapping the on-premises infrastructure to a proposed cloud infrastructure; (3) generating, using an artificial intelligence engine, an architecture diagram of the cloud infrastructure; (4) validating the proposed cloud infrastructure against organizational standards; (5) generating infrastructure as code for the proposed cloud infrastructure; (6) performing a code scan on the infrastructure as code; (7) identifying deviations from the infrastructure as code from the code scan; (8) generating a pull request for code from a source code repository based on the deviations; (9) identifying services and components to be deployed in the infrastructure as code; and (10) deploying the services and components to a cloud environment.

### RELATED APPLICATIONS

This application claims priority to, and the benefit of, Indian Patent Application number 202411031028, filed Apr. 18, 2024, the disclosure of which is hereby incorporated, by reference, in its entirety.

### BACKGROUND OF THE INVENTION

### 1. Field of the Invention

Embodiments relate to systems and methods for automatically optimizing computer infrastructure by implementing multiple lines of defense in software development lifecycles.

### 2. Description of the Related Art

In general, infrastructure optimization tooling identifies issues after the fact and reports on them but does not solve the issues. Further, it only checks for issues one time at the end, resulting in a single point of failure.

In addition, cloud providers generally do not provide pricing information.

### SUMMARY OF THE INVENTION

Systems and methods for automatically optimizing computer infrastructure by implementing multiple lines of defense in software development lifecycles. According to an embodiment, a method may include: (1) receiving, by a line of defense computer program, information for on-premises infrastructure and costs associated with the on-premises infrastructure; (2) mapping, by the line of defense computer program, the on-premises infrastructure to a proposed cloud infrastructure; (3) generating, by the line of defense computer program and using an artificial intelligence engine, an architecture diagram of the cloud infrastructure; (4) validating, by the line of defense computer program, the proposed cloud infrastructure against organizational standards; (5) generating, by the line of defense computer program, infrastructure as code for the proposed cloud infrastructure; (6) performing, by the line of defense computer program, a code scan on the infrastructure as code; (7) identifying, by the line of defense computer program, deviations from the infrastructure as code from the code scan; (8) generating, by a rectification engine, a pull request for code from a source code repository based on the deviations; (9) identifying, by the line of defense computer program, services and components to be deployed in the infrastructure as code; and (10) deploying, by the line of defense computer program, the services and components to a cloud environment.

In one embodiment, the information comprises host information.

In one embodiment, the information comprises anticipated CPU and memory requirements.

In one embodiment, the method may also include: generating, by the line of defense computer program, a predicted bubble cost for transitioning to the proposed cloud infrastructure.

In one embodiment, the method may also include: identifying a component or service that is contrary to a recommended component or service for the cloud environment.

In one embodiment, the rectification engine generates fix infrastructure as code to right size the proposed cloud environment.

In one embodiment, the method may also include: shutting down, by the line of defense computer program, part of the on-premises infrastructure in response to a determination that the part of the on-premises infrastructure will not be used for a period of time.

In one embodiment, the method may also include: receiving, by the line of defense computer program, a decommissioning date to transition to the proposed cloud infrastructure.

In one embodiment, the method may also include: retrieving, by the line of defense computer program and from a cloud provider for the cloud environment, a cost for the proposed cloud infrastructure.

In one embodiment, the method may also include: identifying, by the line of defense computer program, a cost saving opportunity based on resource utilization from a cloud provider for the cloud environment and from on-premises resource utilization; and right sizing, by the rectification engine, the infrastructure as code.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for implementing multiple lines of defense in software development lifecycles according to an embodiment;

FIG. 2 illustrates a method for implementing multiple lines of defense in software development lifecycles according to an embodiment;

FIG. 3 depicts an exemplary computing system for implementing aspects of the present disclosure.

### DETAILED DESCRIPTION OF PREFERRED EMBODIMENTS

Embodiments relate to systems and methods for implementing multiple lines of defense in software development lifecycles.

Embodiments may automate cost defense in the planning, development, and operating stages of a product's software development lifecycle. Embodiments may also automatically fix issues that are detected early in the software development cycle.

In the development and operating stages of a project, the automation may include identifying expensive code, generating less expensive code, and creating a pull request (PR) to deploy the fix. The fixes may be automatically identified with, for example, SourceGraph queries. The automated fixes may be made with multiple technologies. If the fix is relatively simple, it may be made using either SourceGraph or OpenRewrite recipes to provide a deterministic output of new code. The PR created may be fully trusted by the approving software engineering team. In more complex situations, a Large Language Model (LLM), may generate the new code. The LLM output is more powerful and may handle more complex situations, but the result will not be deterministic. Thus, the LLM result may require more human review of the PR.

Regardless of how the new code was created, one or more LLMs may be used to explain the PR to the approver. The first LLM may give the context needed to approve including, what changed (description of the code change), why the change is needed (severity level and problem description), a calculated dollar savings associated with the change (cost savings estimation) the risk associated with the change (confidence level), how much work must be done in addition to approving the PR (difficulty level), the environment of the change (dev, test, prod, etc.) and further reference reading on the topic of the change and how test the change.

The second LLM may receive the output of the first LLM and may verify and polish the content before it is added to a pull request.

An illustration of a prompt for the first LLM to generate context for a code change made with SourceGraph. The code is changed to reduce the costly retention period of log files. The context of the prompt includes the SourceGraph query used to make the change, i.e., the LLM is provided with the code that generated the change and prompted to explain the change. “Please provide a detailed description based on the information which contains the pattern I searched in SourceGraph, the solution to fix the problem, the impaction provided as a reference to understand why we make this change, if it is empty just ignore it. I'm going to use this description in a pull request in bitbucket for other developers to approve. Please describe it in a detailed and professional way. Please analysis the searching pattern, understand what it want to search and base on it to generate a “Problem description”, makes sure to not include the original search pattern in the description. And please review the solution and replace it with a better one if find and describe it in a human language to provide a “Description” under “Solution”, and searching on some tool like AWS pricing to figure out how much cost or how many time is going to be saved and add it separately in to “Cost saving estimation” and “Time saving estimation” under “Solution”, make sure the source tool is included. And please according to the severity of the problem and the cost and performance improvement level to provide a severity level and reason in “Severity level”. And please measure if the solution can possible break something in order to generate a confident level and reason in “Confident level”. And based on if how many additional process like access request outside of just approve the pull request to provide a difficult level and list all the additional processes needed in “Difficulty level”. Please provide the environment chose from non-prod, prod or all environment in “Environment”, the information can be searched in the pattern, for example if a file named with prod is excluded, it represents the non prod environment and vice versa, if not find a specific identifier for environment just put all there. Please add any reference in the “Reference”. Please add the author in the “Author”, describing who generated the PR. The information is: searching pattern “‘[{‘repositoriesMatchingQuery’: ‘context: global patterntype:regexp-file:prod.tfvars-file:main.tf \hat{ }[\hat{ }#].*cloudwatch_log_retention_in_days=[2−9]|[1-9][0-9]+fork: yes’}]’”, solution “‘[{‘run’:‘\nfor file in “${{join repository.search_result_paths \\n}}”; \n\ndo\n\n sed-i \'s/cloudwatch_log_retention_in_days=[2-9] [0-9] *\\+/cloudwatch_log_retention_in_days=1/g\′$ {file}\n\ndone;\n’, ‘container’: ‘ubuntu:18.04’}]’”, impaction ″″″, author “‘This PR is generated by CostFit, which contains an automated LLM tool to optimize your repo. Please report an issue or provide feedback on this PR, contact US: xxxx@organization.com Please provide the description in the json format: {“Environment”: . . . , “Problem description”: . . . , “Solution”: {“Description”: . . . , “Cost saving estimation”: . . . , “Time saving estimation”: . . . }, “Difficult level”: . . . , “Confident level”: . . . , “Severity level”: . . . , “Reference”: . . . , “Author”: . . . }

Note that this prompt is exemplary only, and the prompt may be formatted in other ways as is necessary and/or desired.

These are sample results from the first LLM: {“Environment”: “Non-prod”, “Problem description”: “The search pattern is looking for instances where the ‘cloudwatch_log_retention_in_days’ parameter is set to a value greater than 1 in non-production environment files. This parameter determines the number of days that CloudWatch Logs retains log events. Setting this to a high value in non-production environments can lead to unnecessary costs and storage usage.”, “Solution”: {“Description”: “The proposed solution is to run a script that searches for all instances of ‘cloudwatch_log_retention_in_days’ with a value greater than 1 and replaces them with a value of 1. This will ensure that log events are only retained for one day in non-production environments, reducing storage usage and costs.”, “Cost saving estimation”: “The exact cost savings will depend on the volume of log events and the current retention period. However, according to AWS CloudWatch pricing, reducing the retention period from 30 days to 1 day could save approximately $0.03 per GB of log data per month.”, “Time saving estimation”: “The time savings will also depend on the volume of log events and the current retention period. However, reducing the retention period will decrease the time spent managing and searching through old log events.”}, “Difficult level”: “Low. The only additional process required is to approve the pull request.”, “Confident level”: “High. The proposed solution is a simple change to a configuration parameter and is unlikely to break anything.”, “Severity level”: “Medium. While the current configuration is not causing any immediate issues, it is leading to unnecessary costs and storage usage.”, “Reference”: “AWS CloudWatch Pricing: https://aws.amazon.com/cloudwatch/pricing/”, “Author”: “This PR is generated by CostFit, which contains an automated LLM tool to optimize your repo. Please report an issue or provide feedback on this PR, contact US: xxxx@organization.com”}.

An example of a prompt for the second LLM is as follows: “Please review the description, make sure it is professional, clear, given all the details, include all the necessary reference source, provide the correct environment, but not necessary to be more specific rather than chose from prod/non-prod/all, makes sure not to mention the problem is based on the searched pattern in the response, and provide the best solution to solve the problem. “‘{“Environment”: “Non-prod”, “Problem description”: “The search pattern is looking for instances where the ‘cloudwatch_log_retention_in_days’ parameter is set to a value greater than 1 in non-production environments. This parameter determines the number of days that CloudWatch Logs retains log events. Setting this to a high value in non-production environments can lead to unnecessary costs and storage usage.”, “Solution”: {“Description”: “The proposed solution is to run a script that searches for all instances of ‘cloudwatch_log_retention_in_days’ with a value greater than 1 and replaces them with a value of 1. This will ensure that log events are only retained for one day in non-production environments, reducing storage usage and costs. The script will be run in an Ubuntu 18.04 container.”, “Cost saving estimation”: “The cost savings will depend on the current coudwatch_log_retention_in_days' settings and the volume of log events. However, based on AWS CloudWatch pricing, reducing the retention period from 30 days to 1 day could potentially save up to 97% of the costs associated with log storage.”, “Time saving estimation”: “The time savings will also depend on the number of instances that need to be updated. However, the script should be able to process each instance in a matter of seconds, potentially saving several hours of manual work.”}, “Difficult level”: “Low. The only additional process required is to approve the pull request.”, “Confident level”: “High. The script only modifies the ‘cloudwatch_log_retention_in_days’ parameter and does not affect any other parts of the code. Therefore, it is unlikely to break anything.”, “Severity level”: “Medium. While the issue does not affect the functionality of the code, it can lead to unnecessary costs if not addressed.”, “Reference”: “AWS CloudWatch Pricing: https://aws.amazon.com/cloudwatch/pricing/”, “Author”: “This PR is generated by CostFit, which contains an automated LLM tool to optimize your repo. Please report an issue or provide feedback on this PR, contact US: xxxx@organization.com”} Please provide the description in the following json format: {“Review”: {“Score of the response”: . . . , “Reason”: . . . }, “Update response”: . . . }

An example response from the second LLM is as follows: {“Review”: {“Score of the response”: 9, “Reason”: “The response is clear, professional, and provides all the necessary details. It includes a reference source and correctly identifies the environment. The problem is not explicitly stated to be based on the search pattern in the response, and a solution is provided. However, the ‘Problem description’ could be slightly more specific about the issue at hand.”}, “Update response”: {“Environment”: “Non-prod”, “Problem description”: “The issue arises when the cloudwatch_log_retention_in_days' parameter is set to a value greater than 1 in non-production environment files. This parameter determines the number of days that CloudWatch Logs retains log events. A high value in non-production environments can lead to unnecessary costs and storage usage.”, “Solution”: {“Description”: “The proposed solution is to run a script that searches for all instances of ‘cloudwatch_log_retention_in_days’ with a value greater than 1 and replaces them with a value of 1. This will ensure that log events are only retained for one day in non-production environments, reducing storage usage and costs.”, “Cost saving estimation”: “The exact cost savings will depend on the volume of log events and the current retention period. However, according to AWS CloudWatch pricing, reducing the retention period from 30 days to 1 day could save approximately $0.03 per GB of log data per month.”, “Time saving estimation”: “The time savings will also depend on the volume of log events and the current retention period. However, reducing the retention period will decrease the time spent managing and searching through old log events.”}, Difficult level”: “Low. The only additional process required is to approve the pull request.”, “Confident level”: “High. The proposed solution is a simple change to a configuration parameter and is unlikely to break anything.”, “Severity level”: “Medium. While the current configuration is not causing any immediate issues, it is leading to unnecessary costs and storage usage.”, “Reference”: “AWS CloudWatch Pricing: https://aws.amazon.com/cloudwatch/pricing/”, “Author”: “This PR is generated by CostFit, which contains an automated LLM tool to optimize your repo. Please report an issue or provide feedback on this PR, contact US: xxxx@organization.com”}}.

Embodiments may provide multiple opportunities to identify issues before a traditional system's first, and only, check.

Embodiments may present cloud provider pricing with any available discounts in real time. Embodiments may further include taxes, thereby providing a total cost for the cloud service.

Embodiments may automatically identify and reduce the “bubble cost” of simultaneously paying for both legacy on-prem infrastructure and new cloud-based infrastructure.

To automatically optimize infrastructure selection, embodiments may query cloud providers (e.g., via Application Programming Interfaces, or APIs) for their real time pricing on all services and may apply any discounts and taxes. Embodiments may then filter the services and options with a tech bias for the entity. Embodiments may then apply rules based on the application history and other attributes. This may prevent, for example, purchases that do not meet entity guidelines (e.g., preventing the purchase of software with a license fee when similar software is available without a license fee), selection of more expensive options (e.g., preventing the selection of unnecessary computing power), purchasing excessive capacity (e.g., preventing the purchase of much more compute power than historically used), purchases that are anomalous (e.g., preventing a spend that is large relative to the application budget), etc.

To automatically or semi-automatically minimize bubble cost and to fine tune infrastructure budgets, embodiments may collect monthly deployment/decommissioning plans from application owners and may (1) calculate the bubble cost versus budget and may automatically suggest the required decommissioning schedule of on-premises infrastructure components for the application, and (2) may automatically feed monthly spend/save info, associated with the deployment/decommissioning schedule, to the annual budgeting system to set the next budget.

In the development stage, to optimize costs, embodiments may detect issues and may generate any code fixes to, for example, prevent the deployment of unnecessarily costly infrastructure, to prevent deployment without a proper configuration set, to prevent deployment without proper cost tags, and/or to prevent the deployment of infrastructure that does not match what was approved in the planning stage (i.e., prevents deployments that violate the approved permit to build).

In the development stage, to prevent unexpected cost increases, the Infrastructure as Code (IAC) may be priced and compared to the price of the previous version. If the price change is unexpected and exceeds a threshold, a notification (e.g., warning messages, emails, etc.) may be triggered. In embodiments, only authorized personnel may be able to make such risky deployments.

Embodiments may further scan infrastructure as code committed to the develop branch in the source control system. For example, embodiments may not only identify issues that violate a ruleset but may also automate a fix for the issues identified.

The results of the scan may be provided to the same ruleset that was used in the planning stage (e.g., depending on configuration, anything found here is automatically prevented from deployment) and/or to a ruleset that identifies issues that were not relevant during the planning stage and only surface in the deployment stage (e.g., deployment of servers that do not have a schedule to turn them off during non-business hours is blocked).

A rectification engine may create the IAC fix and raises a pull request in the bitbucket for the development team to accept the solution and merge. Merge can be declined with valid justification, if needed. A blocked deployment can be pushed through with a manager override and multiple person checks.

In the operating stage, embodiments may identify opportunities for an application by running cloud provider rulesets to identify idle resources, cloud rulesets such as those to automatically clean up expired database snapshots, on-premises rulesets to check for issues such as right sizing memory, etc. Embodiments may automatically fix simple issues by generating and running code, may automatically create infrastructure as code for issues requiring human approval, such as switching a server type from graviton to serverless, may fix configurations that drifted since the development stage, may fix configurations that slipped through earlier stages (e.g., due to any evasive tactic by developers), may identify cost anomalies and generate new ruleset rules for the development stage, etc. Any issues that are too complex to fix automatically may be tracked to conclusion through a workflow.

Embodiments may provide a planning defense, that may provide information regarding over/under budgeting of applications with explanatory notes, scheduling for cloud deployments and on-premises decommissions, bubble costs, cloud provider pricing (with discounts), an identification of infrastructure that does not follow a technical bias (e.g., one service is preferred over another), etc. In the planning stage, the key goals achieved are bubble cost minimization and cloud infrastructure cost minimization. The bubble cost may be minimized by suggesting optimal decommissioning schedules given constraints entered by the application team. The cloud infrastructure cost may be minimized by suggesting low-cost architecture that meets any organizational technology bias and cloud provider best practices.

Embodiments may provide an operating defense that may identify cost savings opportunities, may automatically create a pull request for simple issues and may provide instructions for resolving complex issues, may score applications according to maturity, and may maintain a history of issues with Root Cause Analysis (RCA) and fix information. In addition, the operating defense may automatically route the issues to Site Reliability Engineers (SREs) as incidents in the incident tracking system and as metrics that, if they breach Service Level Objectives, will impact the error budget in the SRE dashboard. The incidents and error budget impacts may encourage SREs to perform a root cause analysis on the issues. In the operating phase, a goal may be to operate with maximum efficiency by minimizing the size of costs and the length of time the costs are incurred. The length of time costs incurred may be minimized via the aforementioned automatic routing of incidents to the SRE toolset. The application checks the size of the issues and raises incidents with a severity and priority that corresponds to the size of the issue. Larger incidents are given higher priority to solve faster. Additionally, to minimize the length of time a cost is incurred, the application may automatically turn off infrastructure in non-production environments when not in use. For example, on nights, holidays and weekends the system will detect no infrastructure usage for an extended period. During this time, it will automatically shut down clusters and databases. This can save up to 70% of usage costs.

Embodiments may provide a deployment defense that may prevent costly deployments. Embodiments may automatically scan cloud APIs, may automatically create a pull request to fix infrastructure that is contrary to a recommendation or technical bias, may warn application owners of anomalous spend that is large relative to a budget.

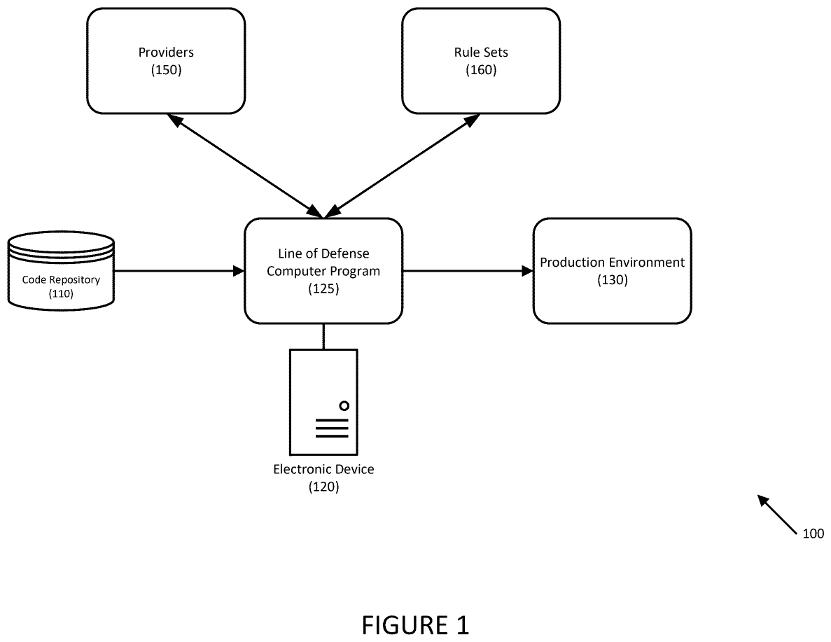

Referring to FIG. 1, a system for implementing multiple lines of defense in software development lifecycles is disclosed according to an embodiment.

System 100 may include code repository 110, which may store code as it is being developed. System 100 may further include electronic device 120, which may execute line of defense computer program 125. Line of defense computer program may retrieve code from code repository 110 and may apply multiple checks to the code. In one embodiment, the checks may be directed to optimizing the cost associated with the code.

System 100 may further include production environment 130, where code may be deployed to, for example, a cloud provider (e.g., cloud provider 150).

Line of defense computer program 125 may retrieve data from providers 150 and may retrieve rules from rules sets 160.

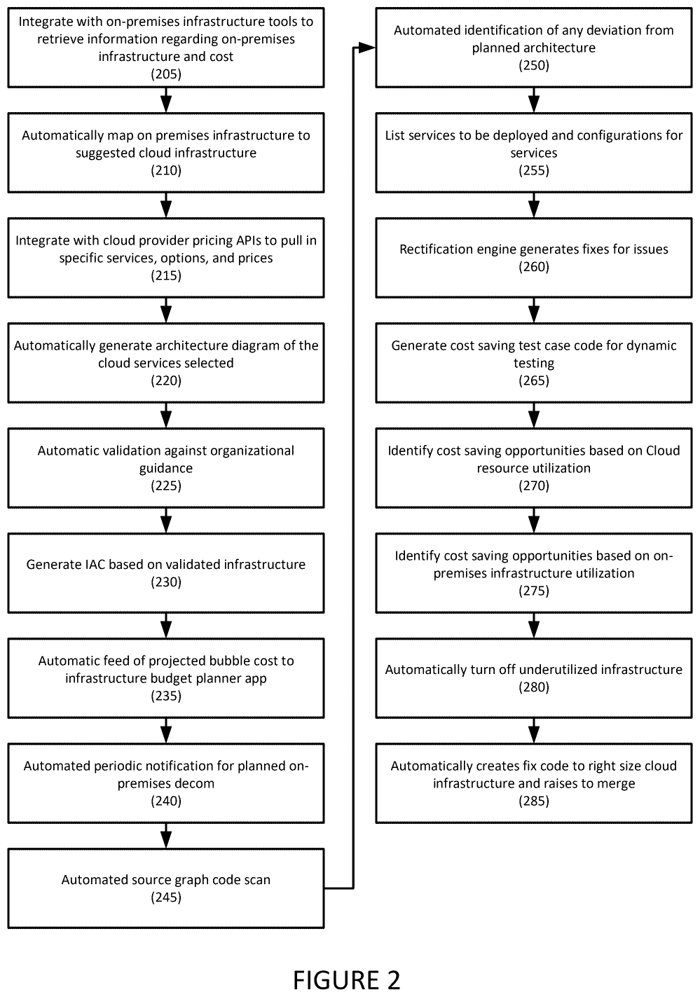

Referring to FIG. 2, a method for implementing multiple lines of defense in software development lifecycles is disclosed according to an embodiment.

In embodiments, the method may start with a planning stage. In step 205, a computer program, such as a line of defense computer program, may integrate with on-premises tools to retrieve information, such as a list, of on-premises infrastructure and its costs associated with the on-premises infrastructure. For example, the computer program may receive information on a host (e.g., a cloud provider), anticipated requirements (e.g., CPU, memory, availability), etc. It may further display how much an app is over/under budget with explanatory notes each month at application level.

In one embodiment, the computer program may provide different views of the information. For example, the computer program may use a large language model to summarize notes from all the applications and may present this information.

In another embodiment, the computer program may provide a time-based view, such as a monthly calendar view, so application owners can plan their scheduled cloud deployments and on-prem decommissions. The computer program, using artificial intelligence, may recommend decommissioning schedules that fit within a budget.

In one embodiment, to help with planning, the computer program may display the existing on-premises assets and their prices so that application owners can tag each one with a decommissioning date.

In step 210, the computer program may automatically map the on-premises infrastructure to a suggested cloud infrastructure, such as that provided by an authorized cloud provider. Any cloud providers that are not preferred by the organization may be identified for the user.

In step 215, the computer program may integrate with cloud provider pricing APIs for cloud providers to retrieve the cost for the cloud infrastructure, such as that for specific services and options. Any organizational discounts may be applied.

In step 220, the computer program may leverage an artificial intelligence engine, such as Open AI, to generate an architectural diagram of the cloud infrastructure.

In step 225, the computer program may retrieve organizational standards, policies, and/or rules, and may validate the cloud infrastructure against the standards, policies, and/or rules. Examples of rules may include security requirements, preferred vendors (e.g., cloud providers), a budget, etc. Examples of such may include a policy directed toward decommissioning on-premises assets due to increasing costs, setting a cap that prevents cloud costs from exceeding on-premises costs, etc.

If the validation fails, this may be a hard block or a soft block depending on configuration for each individual rule. Hard bocks prevent sending the plan into the budget process, while a soft block can either provide an informational warning to the user, or it may require manager approval to proceed.

In embodiments, the result of the planning stage may be provided to budgeting process after, for example, passing checks such as ensuring the on-premises expenditures are not increasing without approval.

In step 230, the computer program may generate the IAC for the validated cloud infrastructure.

Once planning is complete, in step 235, the computer program may generate and provide a feed of projected bubble cost to a budget planning application for the organization. For example, to calculate the bubble cost, the computer program must know the current on-premises cost as well as the expected cloud cost. The bubble cost may be calculated as the planned on-premises cost plus the expected cloud cost minus the on-premises cost before transitioning. The bubble cost may be adjusted for organic growth (e.g., if growth is 5%, then 5% may be subtracted from the bubble cost.

If the bubble cost is beyond threshold, the computer program may inform the user or the application owner that they need to decommission legacy infrastructure in smaller chunks faster. The computer program may provide specific suggestions, such as making four quarterly decommissions instead of two large decommissions.

In step 240, the computer program may receive periodic notification of planned on-premises software decommissioning. For example, the computer program may present the user (e.g., an application owner) with a list of their legacy on-premises infrastructure and its cost, as well as a list of proposed new target cloud infrastructure based on a mapping from on-premises to cloud services. The user may then select the date to decommission each piece of legacy infrastructure and may confirm or edit the target cloud infrastructure.

Next, in the process is the development stage. In step 245, the computer program may perform an automated SourceGraph code scan. For example, the computer program may use a program or service that scans the IAC quickly and at low cost.

In step 250, based on the SourceGraph code scan, the computer program may identify any deviations from the cloud infrastructure. In one embodiment, the computer program may receive a list of items being deployed from the code scan and may compare that to the planned list.

In step 255, the computer program may have the list of services to be deployed and the configurations for those services. The list of services may be evaluated using a ruleset that may identify missing elements, non-preferred services (e.g., a database that has a licensing cost), etc. In one embodiment, the computer program may use an artificial intelligence engine to identify any components that are contrary to the cloud provider's documented recommendations from their websites.

In step 260, the computer program may use a rectification engine to generate fixes for any issues. For example, the computer program may raise an automated pull request to a source code repository for code to merge into the IAC.

In one embodiment, merges may be approved manually and may be merged automatically if there is no merge conflict.

By automatically raising a pull request, embodiments shift the costs left. This is in contrast to fixing a bad deployment.

After the development stage is complete, in step 265, the computer program may generate a cost saving test case code for dynamic testing to ensure that costs are within configurable thresholds of what is expected. For example, the computer program may receive cost saving opportunities provided by the cloud providers and may display them. In embodiments, the computer program may automatically act upon the cost savings opportunities using the artificial intelligence engine to generate the fix. The computer program may then raise a pull request.

In one embodiment, the computer program may use an artificial intelligence engine to determine whether decide if an instance or a cluster should be shut down. Machine learning with an extreme gradient boosting algorithm may predict whether the instance or cluster will be used again within a configurable period (e.g., one hour), and if not, will trigger a shut down. The machine learning may take into account current and historical data point features, including the environment (dev, test, prod), time of day, day of year, the last time the instance was used, number of users logged in, role of users logged in, etc.

Next, in the operation phase, in step 270, the computer program may identify cost saving opportunities based on resource utilization. For example, the computer program may receive real-time or asynchronous utilization information from the hosts (e.g., cloud providers). The computer program may identify unused or underutilized CPU, memory, etc.

In step 275, the computer program may identify cost saving opportunities based on on-premises infrastructure utilization. For example, the computer program may receive real-time or asynchronous utilization information from the on-premises hosts or cloud servers. The computer program may identify unused or underutilized CPU, memory, etc.

In step 280, the computer program may automatically turn off underutilized infrastructure in development and test environments.

In step 285, the computer program may use the rectification engine to create fix code to right size the IAC for the cloud infrastructure. In one embodiment, the computer program may checkout code on feature branch. This is a copy of the main code which sits in the develop branch and may make a change to the code in the feature branch and raise a pull request to merge the updated code back into the develop branch. When the pull request is approved by a human, the code is merged and the develop branch will reflect the update.

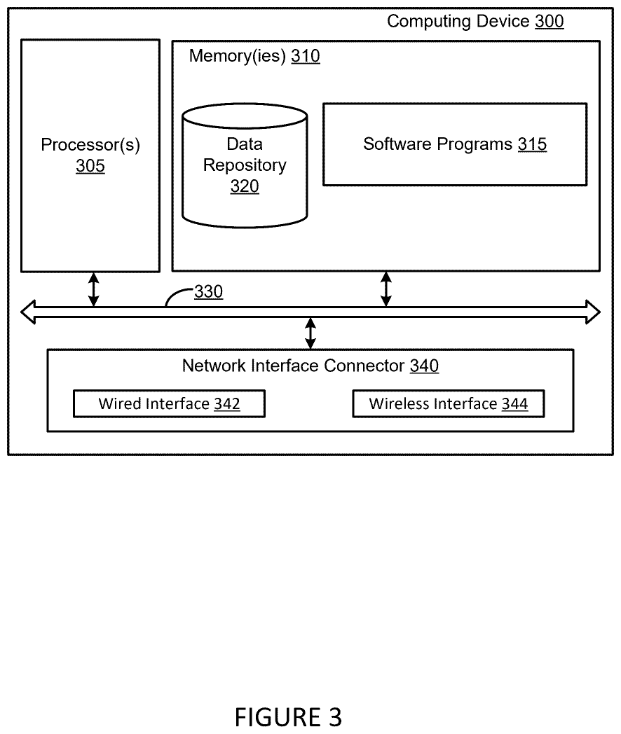

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

The disclosure of U.S. patent application Ser. No. 18/527,074, filed Dec. 1, 2023, is hereby incorporated, by reference, in its entirety.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a line of defense computer program, information for on-premises infrastructure and costs associated with the on-premises infrastructure;
mapping, by the line of defense computer program, the on-premises infrastructure to a proposed cloud infrastructure;
generating, by the line of defense computer program and using an artificial intelligence engine, an architecture diagram of the cloud infrastructure;
validating, by the line of defense computer program, the proposed cloud infrastructure against organizational standards;
generating, by the line of defense computer program, infrastructure as code for the proposed cloud infrastructure;
performing, by the line of defense computer program, a code scan on the infrastructure as code;
identifying, by the line of defense computer program, deviations from the infrastructure as code from the code scan;
generating, by a rectification engine, a pull request for code from a source code repository based on the deviations;
identifying, by the line of defense computer program, services and components to be deployed in the infrastructure as code; and
deploying, by the line of defense computer program, the services and components to a cloud environment.

2. The method of claim 1, wherein the information comprises host information.

3. The method of claim 1, wherein the information comprises anticipated CPU and memory requirements.

4. The method of claim 1, further comprising:
generating, by the line of defense computer program, a predicted bubble cost for transitioning to the proposed cloud infrastructure.

5. The method of claim 1, further comprising:
identifying a component or service that is contrary to a recommended component or service for the cloud environment.

6. The method of claim 1, wherein the rectification engine generates fix infrastructure as code to right size the proposed cloud environment.

7. The method of claim 1, further comprising:
shutting down, by the line of defense computer program, part of the on-premises infrastructure in response to a determination that the part of the on-premises infrastructure will not be used for a period of time.

8. The method of claim 1, further comprising:
receiving, by the line of defense computer program, a decommissioning date to transition to the proposed cloud infrastructure.

9. The method of claim 1, further comprising:
retrieving, by the line of defense computer program and from a cloud provider for the cloud environment, a cost for the proposed cloud infrastructure.

10. The method of claim 1, further comprising:
identifying, by the line of defense computer program, a cost saving opportunity based on resource utilization from a cloud provider for the cloud environment and from on-premises resource utilization; and
right sizing, by the rectification engine, the infrastructure as code.
